(19) United States
(12) Patent Application Publication
(10) Pub. No.: US 2013/0262341 A1
(43) Pub. Date: Oct. 3, 2013

(54) Classification Structure and Uses Thereof

(71) Applicant: LCE RISK, Haywards Heath (GB)

(72) Inventors: Kevin Bourne, Sussex (GB); Gordon Morrison, Sussex (GB)

(73) Assignee: LCE Risk, Haywards Heath (GB)

(21) Appl. No.: 13/853,703

(22) Filed: Mar. 29, 2013

Related U.S. Application Data
(60) Provisional application No. 61/618,012, filed on Mar. 30, 2012.

(51) Int. Cl. G06Q 40/06

(52) U.S. Cl. CPC G06Q 40/06
USPC 705/36 R

(57) ABSTRACT

Aspects relate to a control process that may be utilized to benchmark and quantitatively measure global corporate and industrial engagement in the transition between an incumbent High Carbon Economy (HCE) and a rapidly developing Low Carbon Economy (LCE). Embodiments may implement a 9-point industrial engagement matrix configured to filter entities based on the criteria, such as: engagement, action, and event criteria. The determination may comprise categorizing with the engagement criteria, a first output of the first entity as one of a good, a product, or a service. Further implementations may determine with the action criteria, that the first output satisfies one of a plurality of global event conditions comprising at least one of: climate change, resource depletion and environmental erosion. Still other embodiments may correlate an industrial action condition to the global event condition. For example, the industrial actions may comprise at least one of: adapting, mitigating, and remediating.

### PRIORITY INFORMATION

This application claims priority to U.S. Prov. Pat. App. No. 61/618012, entitled “Classification Structure and Uses Thereof”, filed Mar. 30, 2012, the content of which is incorporated by reference in its entirety for any and all non-liming purposes.

### BACKGROUND

Understanding the scale, velocity & direction of the low carbon economy and how it impacts the commercial activities of companies is one of the most urgent challenges and risk issues facing the global economy. Creating a common structural framework which is able to identify & attribute company engagement in the economic transition from a high carbon economy to a low carbon economy is a very important tool for the investment industry to begin this global measurement process. Unfortunately, past attempts to understand this change often focused on whether an entity is “green” or “environmentally friendly” from a societal point of view. The same error has been made for inclusion criteria for sectors.

What is needed, therefore, are improved systems and methods that remedy one or more of these deficiencies and may include improved systems and methods for determining what entities, sectors, and/or sub-sectors to include, improved inclusion and classification systems, and other outputs that improve the understanding and permit the measuring of engagement in the transition between an incumbent High Carbon Economy (HCE) and a rapidly developing Low Carbon Economy (LCE).

### SUMMARY

The disclosure relates to an industrial classification system. Unlike many current classification systems, which may not consider a specific entity or sector to be “environmentally friendly”, a sector or entity's generation or provisioning of goods, products or services may still be considered for inclusion. Certain embodiments relate to a fully integrated control process that may be utilized to benchmark and quantitatively measure global corporate and industrial engagement in the transition between an incumbent High Carbon Economy (HCE) and a rapidly developing Low Carbon Economy (LCE) where the existing economic state is rapidly changing as we look to produce goods, products & services that enable us to specifically adapt, mitigate or remediate, the impacts of climate change, resource depletion and environmental erosion all of which are exacerbated by an increasing global population and changing demographic model.

Certain embodiments relate to determining whether to include an entity, sector, and/or sub-sector within an industrial classification system having a plurality of sectors. In certain implementations, at least one sector has a sub-sector. The inclusion criteria may comprise or consist of using an industrial engagement matrix. The engagement matrix may be a 9-point matrix configured to filter entities (and/or sectors/sub-sectors) based on the criteria, such as engagement, action, and event of the sector's or specific entity's offerings. For example, an entity's offering may be categorized with the engagement criteria, as one of a good, a product, or a service. Exemplary systems and methods may determine with action criteria that the first output satisfies one of a plurality of global event conditions, such as for example, comprising at least one of: climate change, resource depletion and environmental erosion.

In one implementation, systems and methods may, upon determining that the categorized first output satisfies a global event condition, correlate an industrial action condition to the global event condition. As an example, the industrial actions comprise at least one of: adapting, mitigating, and remediating. Further aspects may relate to attributing a quantitative revenue value. For example, a revenue value may be attributed to a classified first output of the first entity. Still yet further embodiments, may determine that the quantitative revenue value exceeds a threshold percentage of the total revenue of the entity. In certain implementations, the entity may be categorized according to whether the revenue value exceeds the threshold percentage.

In certain embodiments, systems and methods may determine whether to include a first sector within the plurality of predefined economic sectors using a matrix comprising an industrial engagement matrix configured to filter sectors based on the criteria consisting of: engagement, action, and event. This may be conducted prior to categorizing the first entity into one of a plurality of predefined economic sectors. Certain embodiments may determine that a plurality of an entity's engagements are classified in the same sector, and one of them is further classified in a first sub-sector of the first sector while another is classified in a second sub-sector of the first sector. In response, an aggregate sub-sector may be utilized to classify the plurality of the first entity's engagement in the first sector. Further, in some embodiments, a total aggregate revenue value may be calculated. Still further embodiments, an engagement factor for an entity may be established by referencing the total % of revenues derived from the engagement activities to the entity's free float capitalization to derive a free float adjusted weight. The engagement factor is always attributed to the sector or sub-sector of with the highest engagement factor.

### BRIEF DESCRIPTION OF THE DRAWINGS

The various aspects of the invention are illustrated by way of example and not limited in the accompanying figures in which like reference numerals indicate similar elements and in which:

FIG. 1 illustrates a computer network system that may be used to implement aspects of the invention;

FIG. 2 illustrates a high-level diagram of a computer system that may be used to implement aspects of the invention;

FIG. 3 is a flowchart for an illustrative method of in accordance with various aspects of the invention;

FIG. 4 is an illustrative diagram of a LCE industrial engagement matrix in accordance with various aspects of the disclosure; and

FIG. 5 is an example flowchart in accordance with one embodiment of the invention.

### DETAILED DESCRIPTION

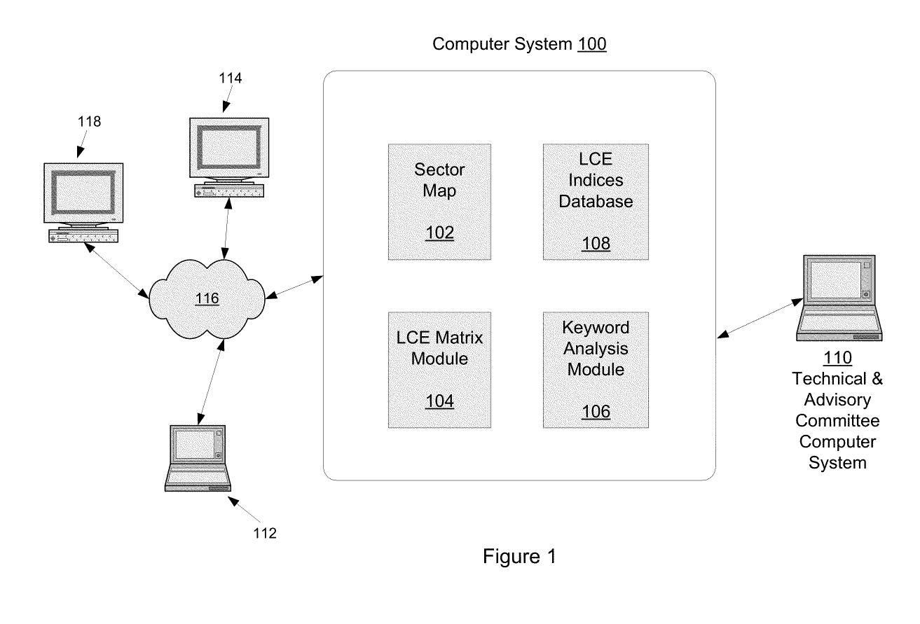

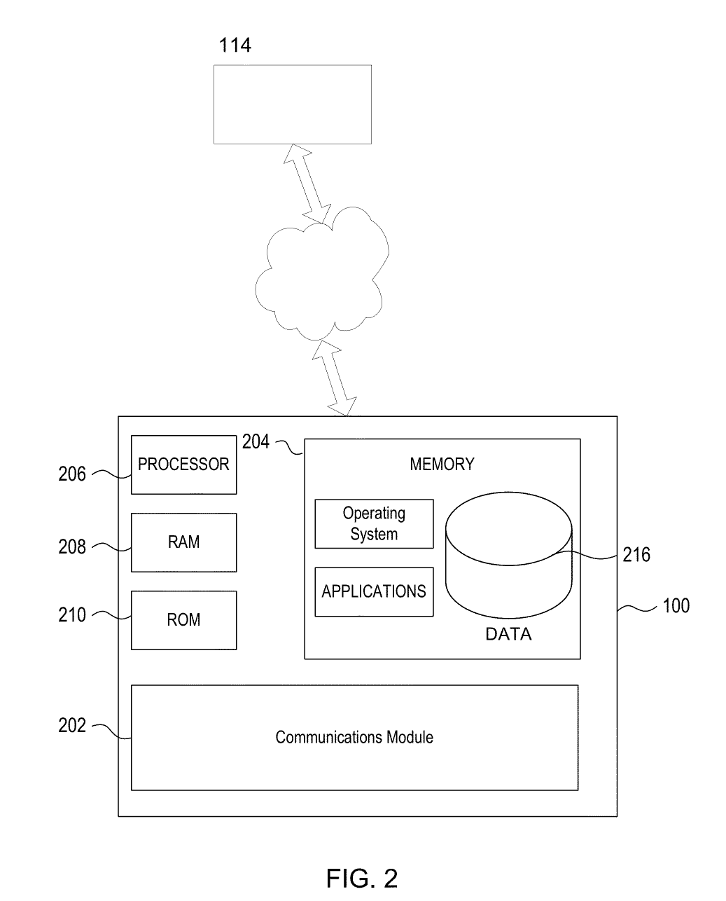

FIGS. 1 and 2 depict an illustrative operating environment that may be used to implement various aspects of the disclosed features. The operating environment is only one example of a suitable operating environment and is not intended to suggest any limitation as to the scope of use, or functionality, of the disclosed features. Aspects of the present disclosure may be implemented with computing devices and networks. A computer system 100 may communicate with a technical and advisory committee through a computer system 110. The computer system 100 may receive information from and transmit information to the committee's computer system 110. In addition, the computer system 100 may communicate over a network 116 with various other computer systems 112, 114, 118.

The computer system 100 may be implemented with one or more mainframes, servers, gateways, controllers, desktops or other computers. The computer system 100 may include one or more modules, processors, databases, mainframes, desktops, notebooks, tablet PCs, handhelds, personal digital assistants, smartphones, gateways, and/or other components, such as those illustrated in FIG. 1. Moreover, computer system 100 may include one or more processors 206 (e.g., Intel® microprocessor, AMD® microprocessor, risk processor, etc.) and one or more memories 204 (e.g., solid state, DRAM 208, SRAM, ROM 210, Flash, non-volatile memory, hard drive 216, registers, buffers, etc.) The processor 206, of computer system 100, may execute computer-executable instructions stored in memory 204 in accordance with aspects of the disclosure. The computer-executable instructions may be comprised of modules in accordance with aspects of the disclosure. Furthermore, the computer system 100 may have one or more communications modules 202 to serve as input/output devices/interfaces with devices such as, but not limited to, keyboard, mouse, voice automation, screen, kiosk, handheld computing device display, voice, Ethernet interface, modem interface, network interface, etc.)

In addition, a computer system 114, such as a computer system corresponding to may be in communication with the computer system 100. In such an embodiment, the system 114 may include a combination of globally distributed computers, controllers, servers, networks, gateways, routers, databases, memory, and other electronic data processing and routing devices. In certain embodiments, electronic information and/or commands performed with or submitted to the computer system 114 may be received and routed to the appropriate device. System 100 may further comprise or be in electronic communication with an LCE indices database 108, which is described later in this disclosure.

The computer system 100 may include a keyword analysis module 106 that may cause the computer system 100 to communicate with third-party computer systems 118 to search for information that may be associated with particular keywords or other search queries. Examples of computer system 118 include, but are not limited to, Google Finance, Reuters, and Bloomberg. The computer system 118 may return search results to computer system 100 for analysis and other actions by the keyword analysis module 106. The keyword analysis module 106 may also identify and record appropriate keywords for future search queries.

The computer system 100 may include a LCE matrix module 104 that may comprise computer-executable instructions configured to implement a low carbon economy (LCE) matrix. In one example, the LCE matrix may be a 9-point LCE industrial engagement matrix that filters companies/products based on three criteria: engagement, action, and event. In one example, engagement factors may include goods, products, and services; action factors may include adapt, mitigate, and remediate; and event factors may include climate change, resource depletion, and environmental erosion.

The computer system 100 may include a sector map 102 that includes table mapping sectors and sub-sectors. Some examples of sectors include an energy generation sector, energy equipment sector, energy management sector, energy efficiency sector, environmental infrastructure sector, environmental resources sector, modal shift sector, and operating shift sector. The sector map 102 may be periodically updated, for example, through communication with the computer system 110, which may be associated with a technical & advisory committee in certain embodiments.

In addition, the computer systems 118, 114, 112, and 110 may include one or more processors, or controllers, that control the overall operation of the computer. The computer systems 118, 114, 112, and 110 may include one or more system buses that connect the processor to one or more components, such as a network card or modem. The computer systems 118, 114, 112, and 110 may also include interface units and drives for reading and writing data or files. Depending on the type of computer device, a user can interact with the computer using a keyboard, pointing device, microphone, pen device, and/or other input device. For example the device may be a personal computer, laptop or handheld computer, tablet pc and like computing devices having a user interface. The electronic device may be a dedicated function device such as personal communications device, a portable or desktop telephone, a personal digital assistant (“PDA”), remote control device, personal digital media system and similar electronic devices.

Computer system 110 is shown in communication with computer system 100. Computer system 100 and computer system 110 may be connected via a T1 line, a common local area network (LAN), a wide area network (WAN), the Internet, or other mechanism for connecting computer devices, including wired or wireless mechanisms.

Computer system 112, 114, 118 are coupled to a network 116. Network 116 may have one or more of the well-known LAN topologies and may use a variety of different protocols, such as Ethernet, or may be another type of network, such as the Internet, a wide area network (WAN). For example, computers and other devices may be connected to the network 116 via twisted pair wires, coaxial cable, fiber optics or other media. Furthermore, the network 116 may include a router to connect the network to the Internet. Such a connection may be via a modem, DSL line, satellite dish or any other device for connecting a computer device to the Internet. Computer systems 112, 114, 118 may communicate with each other and other computers and devices connected to network 116. Alternatively, a wireless personal digital assistant device (PDA) may communicate with network 116 via radio waves. The PDA may also communicate with the computer system 100 via a conventional wireless hub. As used herein, a PDA includes mobile telephones and other wireless devices that communicate with a network via radio waves.

The operations of computer devices and systems shown in FIGS. 1 and 2 may be controlled by computer-executable instructions stored on computer-readable storage medium. Embodiments also may take the form of electronic hardware, computer software, firmware, including object and/or source code, and/or combinations thereof. Embodiment may be stored on computer-readable media installed on, deployed by, resident on, invoked by and/or used by one or more processors, controllers, computers, clients, servers, gateways, networks of computers, and/or any combinations thereof. The computers, servers, gateways, may have one or more controllers configured to execute instructions embodied as computer software. In one example, a processor of computer system 100 may be configured to execute computer-executable instructions that cause the system 100 to calculate an index defining the industrial impact of the transition to a LCE on corporate output.

Of course, numerous additional servers, computers, handheld devices, personal digital assistants, telephones and other devices may also be connected to computer system 100. Moreover, one skilled in the art will appreciate that the topology shown in FIGS. 1 and 2 is merely an example and that the components shown in FIG. 1 may be connected by numerous alternative topologies.

Aspects of this disclosure relate to systems and methods configured to form, refine and/or utilize an industrial classification system. Embodiments may comprise systems and methods configured to determine whether to include at least a first entity among a plurality of known entities within an industrial classification system. As used within this disclosure, an entity refers to any business organization, or a portion thereof, that offers at least one product, good or service. In this regard, modern business entities may comprise several divisions or subsidiaries, which in turn, may have multiple physical locations. Such institutions may have divisions for different products, goods, and/or services. Thus, according to select aspects of the invention, each division may be considered an “entity” in itself for purposes of this disclosure. Yet, in other embodiments of the invention, a collective grouping of various departments and subsidiaries of a corporation may be considered an “entity.”

As indicated above, certain embodiments may distinguish between a “good” and a “product.” As referenced herein, a product encompasses any physical component that is a portion of a final product, but in itself is not the final product. In certain embodiments, a “product” may even be a majority portion of a good or final product however, it still does not meet a substantial portion thereof such that it forms less than a predefined percentage (e.g., 90%) of the final product. In contrast, a “good” refers to the final product that is offered for consumption or use (or in certain embodiments, a substantial portion of the final product, such as over a predefined percentage (e.g., 90%)). As one non-limiting example, polymers used in the production of solar cells may be considered a product, but not the good itself—which is the assembled solar cell. In this regard, unlike certain prior art systems and methods, entities (and/or industrial sectors) that make components for goods, but perhaps not goods, themselves, may nonetheless be included within the industrial classification system.

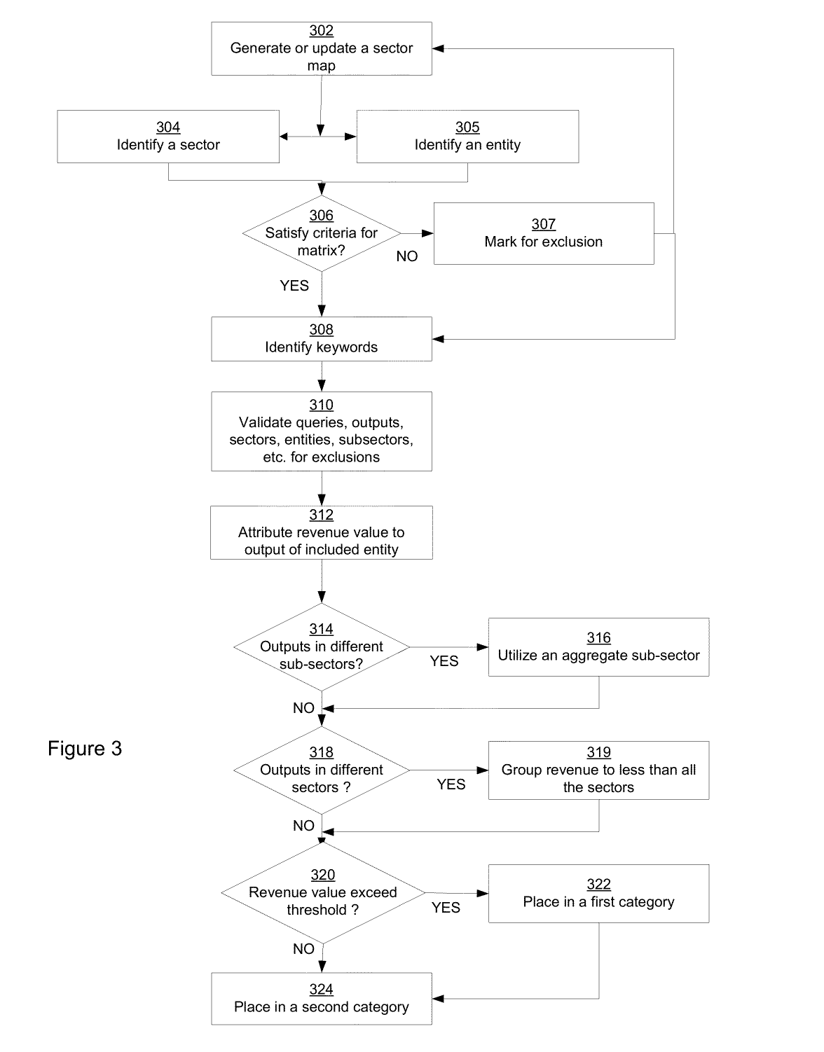

In one embodiment, an entity may be considered for inclusion within the industrial classification based upon its presence within an economic sector. In accordance with an example implementation, economic sectors may be accessed and/or created. As one example, block 302 of FIG. 3 may be implemented to generate a sector map of industry sectors for the industrial classification system. In one embodiment, the map may comprise sector map 102, of computer system 100, of FIG. 1.

Sector map 102 may include a table configured to map sectors and/or sub-sectors. In certain embodiments, a “sector map table” may be stored on a non-transitory computer-readable memory. Sector map 102 may be generated, updated, and/or modified through any computing device, including, for example, a Technical & Advisory Committee computer system 110. In one embodiment, a sector map table or other portion of sector map 102 may comprise sector and sub-sector mappings. In one such embodiment, a sector map table may comprise a plurality of sectors including an energy generation sector, energy equipment sector, energy management sector, energy efficiency sector, environmental infrastructure sector, environmental resources sector, modal shift sector, and/or an operating shift sector, among others. In further embodiments, portions of the sector map 102 may be updated. Updating the sector map 102 may be performed based upon a triggering event, an elapsed period of time, manually, and/or combinations thereof, among others. Updating the table (or any portion of a sector map) may include: removing a sector, adding a new sector, splitting a sector into multiple sectors, merging multiple sectors into a single sector, and/or combinations thereof. Generating or updating sector map 102 may be based upon one or more factors. In one implementation, electronic records, such as an entity's press releases, financial records, documents, and/or other information, either electronic or tangible, may be parsed and analyzed to determine whether the entity is within a specific economic sector or sub-sector. Block 304 may be utilized to identify a specific sector within the sector map 102. Block 304 may be conducted without the subsequent identification of an entity within that sector (or sub-sector) in certain embodiments. Likewise, identification of an entity, such as explained in block 305 below, may be conducted alone.

In one embodiment, block 305 may be implemented to identify a specific entity within a sector or subsector of sector map 102 (e.g., such as a sector identified at block 304). In certain embodiments, block 304 may be absent and block 305 may be implemented to identify at least one entity without first classifying that entity into an LCE sector or sub-sector. In one embodiment, block 305 may be implemented to categorize a first entity into at least one of a plurality of predefined economic sectors based on at least a first output. For example, the output may be a good, a product, or service. In one implementation, the output may be categorized as one of a good, a product, or a service. Examples of identifying possible entities, sectors, or sub-sectors for potential inclusion, such as within one or more actions associated with decision 306 (discussed below), are provided in the context of perfecting the inclusion criteria (see, e.g., blocks 308/310), however, those skilled in the art, with the benefit of this disclosure, will appreciate that such teachings are equally applicable here and throughout this disclosure.

In certain embodiments, inclusion of a sector sub-sector, and/or specific entity within the classification scheme (such as with decision 306), may be determined in accordance with a matrix, which may be implemented with LCE matrix module 104, comprising non-transitory medium(s) having computer-executable instructions configured to implement a low carbon economy (LCE) matrix (e.g., block 306). In certain embodiments, determinations whether to include a sector, sub-sector, and/or a specific entity may utilize the same exact matrix (see, e.g. block 306). In one example, an LCE matrix may be a 9-point LCE industrial engagement matrix that filters sectors, sub-sectors, and/or individual entities based on a plurality of criteria. In one implementation there may be three criteria, such as: engagement, action, and event. Below is an example of an illustrative embodiment of determining whether to include a specific entity within a first sector. For example, the first sector may have previously successfully “passed” the same matrix (having the same criteria) and is thus considered an LCE sector. Nonetheless, although a specific sector (and/or sub-sector) may have completed the inclusion criteria, not every entity within that sector may successfully complete the same matrix criteria. Therefore, in accordance with certain embodiments, matrix module 104 may be implemented to first classify a sector (and possibly a sub-sector) within the industrial classification, and subsequently a plurality of entities within the sector may be validated by using matrix module 104 to confirm that the entities also individually meet the criteria. Unlike many current classification systems, which may not consider a specific entity or sector to be “environmentally friendly”, a sector or entity's generation or provisioning of goods, products or services may still be considered for inclusion.

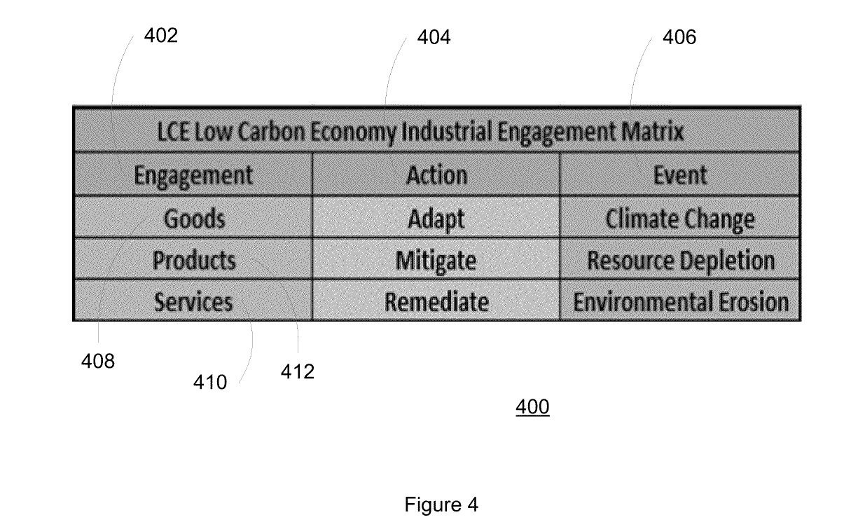

Table 400 of FIG. 4 provides an implementation of an example LCE matrix in accordance with one embodiment. Column 402 lists engagement factors. In one example, the engagement factors may include the determination of whether a selected sector, sub-sector, and/or entity produces an output of a good, product, or service (see elements 408-412). In certain implementations, these are the only engagement factors. In certain embodiments, it may be electronically recorded whether there is a presence of the output(s) is a good, product or service, the quantity of each, and/or further classification of any outputs. In certain embodiments, not every output of the entity is required to be processed by the matrix. Prior experience, execution by the matrix, and/or other factors may negate the need to perform analysis of every good, product or service.

For each output (e.g., good, product or service) of column 402, it may be determined whether these identified (and potentially categorized) outputs satisfy one of a plurality of global event conditions (see column 406 of table 400). In one embodiment, if an output of column 402 does not satisfy a global event, then the first entity may be marked to be excluded from the industrial classification system. Marking an entity (or sector, etc.) may be utilized to prevent further processing of that event, sector, and/or output for a period of time. In the illustrated example of column 406, there are three global event conditions consisting of: climate change, resource depletion and environmental erosion. In further embodiments, other conditions (alone or in conjunction with those shown in column 404 may be utilized.

Upon determining that a specific output (of column 402) satisfies a global event condition (of column 406), decision 306 may further consist of determining a correlated industrial action condition (see column 404) to the global event condition 406. In the illustrated embodiment of FIG. 4, three industrial action conditions consisting of: adapting, mitigating, and remediating are shown. In further embodiments, other conditions (alone or in conjunction with those shown in column 404) may be utilized.

If at decision 306, the entity, sector, and/or sub-sector does not pass the matrix criteria, block 307 may be executed to mark at least sector, sub-sector, and/or output for exclusion. In one embodiment, one or more of blocks 304 or 305 may be implemented to obtain different entities, sectors, goods, etc. to consider for inclusion. In certain embodiments, blocks 308 and/or 310 (discussed immediately below) may be implemented to improve the accuracy of identifying sectors, sub-sectors, and/or outputs for possible inclusion within the classification system.

Block 308 and/or 310 may be utilized to refine, expand, and/or confirm search and/or inclusion criteria that may be utilized by matrix module 104. In one embodiment, if an entity, sector, and/or sub-sector passes the matrix criteria at block 306, one or more of blocks 308 and/or 310 may be implemented. As discussed above, blocks 308 and/or 310 may also be implemented upon failure to successfully pass the matrix. As one example, a first query or search phrase may more accurately identify entities within a specific first sector, however, a second query or group of terms may more accurately determine whether to categorize an entity within a certain sub-sector. In another example, a portion of an entity's goods may be readily identifiable with a first search query, however, a second portion of that same entity's goods or services may be more accurately identified with a second query. One or more aspects of blocks 308 and/or 310 may be performed, at least in part by keyword analysis module 106. In certain embodiments, search words/phrases that have passed a matrix, which may be the same matrix applied for the sector and an entity within the sector may be utilized to conduct multiple searches across various resources. In certain embodiments, publicly available resources having access to a plurality of potential entities may be utilized. Examples may include Google Finance, Reuters, Bloomberg, and/or a plurality of other sources. In certain embodiments, the revenue value may be based upon a free float value. For example, if a public company has a 1 billion dollar market cap, in which 600 million of the 1 billion (e.g., 60%) is publicly tradable, then in one embodiment, percentage revenue of an output, meeting a matrix criteria, may be based upon the 600 million, rather than the 1 billion market cap. In other embodiments, the revenue value may be based upon, but not the same as the free float value. For example, it may be weighted or otherwise adjusted.

Upon identifying a first output (e.g., good, product, or service) of an entity satisfying a matrix, such as the criteria set forth in the matrix module 104, block 312 may be executed to attribute a first quantitative revenue value to that first output. As discussed above, a single entity may have more than a single output, including one or more goods, products or services. In one embodiment, the quantitative output value may be revenues derived from the output. In one embodiment, the revenue value may be gross revenue, yet in another embodiment, it may be net revenue. In one embodiment, a plurality of sources may be considered in the formulation of the revenue value. In one embodiment, public data, such as from Google Finance, Reuters, Bloomberg, and/or a plurality of other sources, may be utilized. In another embodiment, evidence obtained from one or more analysts may be utilized. In yet another embodiment, data produced by the entity itself may be utilized. In certain implementations block 312 may receive information from public data, analyst's data, and the entity's own data. Weighting schemes may be applied to the data if more than one source is utilized. For example, if data from the entity is certified it may be weighted more than another source of data. In another embodiment, if a first source of data is outside of a range of deviation from another source of data, that first data may not be utilized, or scaled to be less significant in the determination of the revenue value.

Further aspects relate to aggregating sub-sectors. In certain embodiments, decision 314 may determine whether the entity of block 312 has a plurality of outputs in a single sector but at least one of those outputs is within a different sub-sector. For example, Company A may offer three services in an alternative energy sector, however, they may span across at least two of wind, solar or biofuel sub-sectors within that sector. In one embodiment, if it is determined at decision 314 that an entity has outputs in at least two different sub-sectors of the same sector, then a new aggregate sub-sector may be utilized (or created), such as at block 316. For example, using the alternative energy sector as an example, each of the revenue values of the three sub-sectors within that sector may be used to calculate a total aggregate revenue value and categorized under an aggregate sub-sector under the alternative energy sector. An aggregate sub-sector may be selectively engaged in some implementations. Utilizing an aggregate sub-sector may be conducted based upon on more factors, such as the quantity of sub-sectors, relative size of the outputs, revenue values and/or other factors.

Further aspects relate to determining whether an LCE entity comprises a first output that is in a different sector than a second output of that same entity (see, decision 318). For example, an entity may have 20 million U.S. dollars of revenue in fish farming (which, in one embodiment, may be classified under an aquaculture sector) and 100 million U.S. dollars in revenue from wind turbines (which, in one embodiment, may be classified under an alternative energy generation). In certain embodiments, the total LCE revenue (20 million+100 million) may be categorized under less than all the sectors, such as a single sector (see, block 319). In one embodiment, the sector having the highest revenue value (alternative energy generation) may be utilized. Thus, in one embodiment, the entity may be assigned 120 million dollars as a revenue value and the revenue value is associated with the alternative energy generation sector. Grouping of sectors may be conducted based upon one or more factors, such as the quantity of sectors, relative size of the outputs, revenue values, and/or other factors. An aggregate sector may be selectively engaged in some implementations. Further, grouping has been discussed relative to sectors and the creation of aggregate groupings has been discussed in relation to sub-sectors. Those skilled in the art would appreciate that each implementation, and derivatives thereof, may be applied to sectors and sub-sectors alike. Further, although the determination of a revenue value has been described prior to the implementation of decisions 316 and 318, those skilled in the art will appreciate that this is merely one embodiment, and other implementations are within the scope of this disclosure. For example, creating an aggregate sector or subsector and/or grouping of sectors or sub-sectors may be based on relative production which may not require the revenue value to be known.

In certain embodiments, decision 320 may be implemented to determine whether that a quantitative revenue value (such as one or more of the values described above) exceeds a threshold level of the total revenue of the entity. The threshold may one of a plurality of layered thresholds. For example, in one embodiment, a plurality of differing percentages is marked as threshold levels. In one implementation, a first threshold may be 25% of the entity's total revenue. In another embodiment, a threshold may be 50%, 75%, and/or other percentages of total revenue. Those skilled in the art will readily appreciate that these are merely examples, and that other thresholds, which may or may not be expressed as percentages, may be utilized without departing from the scope of this disclosure. In one embodiment, the actual revenue value may be utilized without comparison to other revenue figures, such as the total revenue of the entity.

As one example, Company A may have 100 million dollars that has been classified by the matrix as being within at least one LCE sector and company A may have 1 billion dollars in total revenue. Therefore, in one embodiment, it may be determined that 10% of Company A's revenue (100 million/1 Billion) may be compared to a threshold percentage. In one embodiment, the threshold percentages may be: below 25%, 25%, 50%, 75%, and/or greater than 75%. Thus, in one embodiment, the 10% level would be classified as under 25%.

Block 322 may be implemented based upon the determination that the revenue value exceeds the threshold percentage (or falls within a predefined range), and is therefore, categorized in a first category (e.g., 25-50%). In other embodiments, block 324 may be implemented if the revenue value did not exceed the threshold percentage and the entity is classified in a second category (e.g., 0-25%). Block 322 and/or any other implementation may assign a value within that range. For example, anything falling below 25% is assigned a first value, such as 25%, and those values falling between 25% and 50% may be assigned 50%.

In this regard, various attribution strategies may be implemented, including, but not limited to: Overlay strategy, Satellite strategy, Pure-play classification, and Partial-play classification. In an exemplary ‘Pure Play’ classification, it may indicate that the revenues derived from the provision of the qualifying goods, products & services represent an amount greater than a predefined percentage (e.g., 50%) of the entity's total operating revenues for the last accounting year. In an exemplary ‘Partial Play’ classification, it may indicates that the revenues derived from the provision of qualifying goods, products & services represent less than a predefined percentage (e.g., 49%) of the company's total operating revenues for the last accounting year.

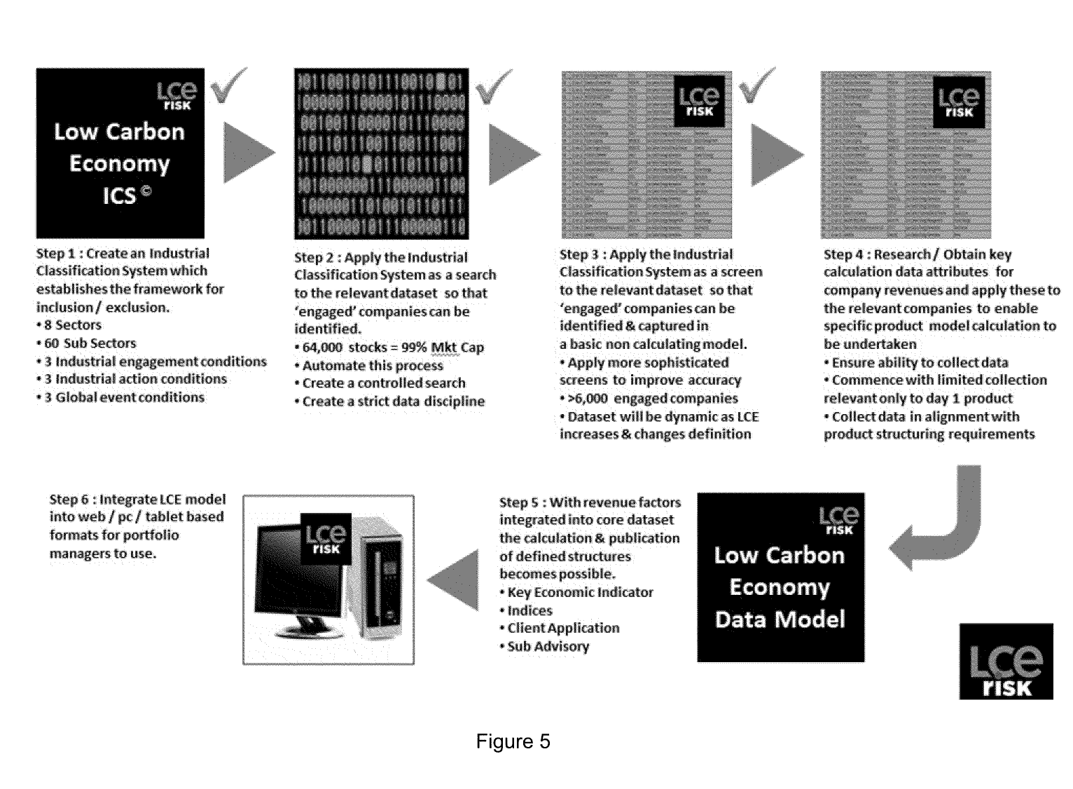

FIG. 5 provides another example flowchart in accordance with an illustrative embodiment of the invention.

Aspects of the disclosure have potential applications in many different prospective market sectors. One or more embodiments relate to creating an index with one or more sectors, sub-sectors, and/or entities. Certain embodiments relate to the creation, maintenance, and trading of one or more indices and financial instruments. Embodiments relate to an index associated with benchmarking corporate engagement in a low carbon economy (LCE). Indices may be constructed as the summation of a series of financial values, or values of economic significance, observed over a specified time period. For example, an index product may be created in accordance with various aspects of the disclosure. The disclosure may be applied broadly in creating any financial or economic index using the herein described methodology. An LCE indices database, such as database 108, may be utilized. LCE indices database may include information identifying companies (e.g., private companies, public companies, etc.) and/or other information related to LCE. The LCE indices database 108 may collect indices data and prepare the data for transmission to users. In one embodiment, the LCE indices database 108 may regularly disseminate/publish updates to the index, including updates to the index that may occur as values being tracked by the index are reported/updated. In some embodiments in accordance with aspects of the disclosure, the data in the LCE indices database may be updated on a daily basis (e.g., at the end of each trading day). A user (e.g., a trader, a market data provider, etc.) operating an electronic device (e.g., computer system 112) may interact with the computer system 100 after being authenticated. The computer system 100 may provide LCE indices data to the user of computer system 112 in response to a request for data.

Continuing with the previous example, in one embodiment the LCE index/indices may be used to provide a tradable financial product based on the index/indices described herein. For example, an exchange (e.g., FTSE, LIFFE, etc.) may offer a financial product that is designed to track the performance of the aforementioned index/indices. For example, an exchange-traded fund/financial product (ETF) may be offered that tracks a particular sector of the aforementioned index/indices such that the weight of the particular companies in the ETF may mirror the weight of the company in the particular sector and/or sub-sector. Similarly, in the derivatives market, futures contracts may be offered that track the index/indices as a whole, or in their particular sector/sub-sectors.

Of course, the methods and systems of the above-referenced embodiments may also include other additional elements, steps, computer-executable instructions or computer-readable data structures. In this regard, other embodiments are disclosed and claimed herein as well. Other features and advantages of the invention will be apparent from the description and drawings and from the claims. In this regard, the present invention has been described herein with reference to specific exemplary embodiments thereof. It will be apparent to those skilled in the art, after review of the disclosure herein, that variations or other embodiments, which utilize the principles of this disclosure, are contemplated without departing from the broader spirit and scope of the disclosure as set forth in the appended claims. All variations and embodiments are considered within the sphere, spirit, and scope of the disclosure.

We claim:

1. A non-transitory computer-readable medium comprising computer executable instructions that when executed by a processor, are configured to perform at least:
with the processor, determining whether to include at least a first entity among a plurality of known entities within an industrial classification system having a plurality of sectors, wherein at least one sector comprises a sub-sector using a 9-point industrial engagement matrix configured to filter entities based on the criteria consisting of: engagement, action, and event, the determination comprising:
categorizing with the engagement criteria, a first output of the first entity as one of a good, a product, or a service;
determining with the action criteria, that the first output satisfies one of a plurality of global event conditions comprising at least one of: climate change, resource depletion and environmental erosion;
upon determining that the categorized first output satisfies a global event condition, correlating an industrial action condition to the global event condition, wherein the industrial actions comprise at least one of: adapting, mitigating, and remediating; and
attributing a first quantitative revenue value to the classified first output of the first entity, the computer-readable medium further comprising instructions that when executed perform the method comprising:
determining that the quantitative revenue value exceeds a threshold percentage of the total revenue of the entity; and
based upon the determination that the revenue value exceeds the threshold percentage, categorizing the entity in a first category, wherein if the revenue value did not exceed the threshold percentage, the entity is classified in a second category.

2. The computer-readable medium of embodiment 1, wherein there are three global event conditions, which consist of: climate change, resource depletion and environmental erosion.

3. The computer-readable medium of embodiment 1, wherein there are three industrial action conditions, which consist of: adapting, mitigating, and remediating.

4. The computer-readable medium of claim 1, wherein the computer-readable medium further comprises computer-executable instructions that when executed perform at least:
prior to categorizing the first entity into one of a plurality of predefined economic sectors, determining whether to include a first sector within the plurality of predefined economic sectors using a matrix comprising an industrial engagement matrix configured to filter sectors based on the criteria consisting of: engagement, action, and event.

5. The computer-readable medium of claim 1, wherein the computer-readable medium further comprises computer-executable instructions that when executed perform at least:
determining that a plurality of the first entity's engagements are classified in the same first sector, in which at least one of the of the plurality of engagements is classified in a first sub-sector of the first sector and at least one of the plurality of engagements is classified in a second sub-sector of the first sector;
in response, utilizing an aggregate sub-sector to classify the plurality of the first entity's engagement in the first sector; and
calculating a total aggregate revenue value.

6. The computer-readable medium of claim 1, wherein the computer-readable medium further comprises computer-executable instructions that when executed perform at least:
establishing an engagement factor for the first entity by referencing the total % of revenues derived from the engagement activities to the entity's free float capitalization to derive a free float adjusted weight.

7. The computer-readable medium of claim 1, wherein the engagement factor is always attributed to the sector or sub Sector of the first entity with the highest engagement factor.

8. A non-transitory computer-readable medium comprising computer-executable instructions that when executed by a processor are configured to perform at least:
with the processor, determining whether to include at least a first entity among a plurality of known entities within an industrial classification system, the determination comprising:
categorizing the first entity into one of a plurality of predefined economic sectors based on at least a first output of the first entity;
categorizing the first output as one of a good, a product, or a service;
determining whether the categorized first output satisfies one of a plurality of global event conditions, wherein if it does not, then the first entity is marked to be excluded from the industrial classification system; and
upon determining that the first categorized first output satisfies a global event condition, determining a correlated industrial action condition to the global event condition.

9. The computer-readable medium of claim 8, wherein there are three global event conditions consist of: climate change, resource depletion and environmental erosion.

10. The computer-readable medium of claim 8, wherein there are three industrial action conditions consist of: adapting, mitigating, and remediating.

11. The computer-readable medium of claim 10, wherein a first quantitative revenue value is attributed to the classified first output, the computer-readable medium further comprising instructions that when executed perform at least:
determining that the quantitative revenue value exceeds a threshold percentage of the total revenue of the entity; and
based upon the determination that the revenue value exceeds the threshold percentage, categorizing the entity in a first category, wherein if the revenue value did not exceed the threshold percentage, the entity is classified in a second category.

12. The computer-readable medium of claim 8, wherein the categorizing the first output as one of a good, a product, or a service occurs before categorizing the first entity into one of a plurality of predefined economic sectors.

13. The computer-readable medium of claim 12, wherein categorization of an output as one of a good, a product, or a service is utilized in the categorization of the first entity.

14. The computer-readable medium of claim 8, wherein the computer-readable medium further comprises computer-executable instructions that when executed perform at least:
prior to categorizing the first entity into one of a plurality of predefined economic sectors, determining whether to include a first sector within the plurality of predefined economic sectors using a matrix comprising a 9-point industrial engagement matrix configured to filter sectors based on the criteria consisting of: engagement, action, and event.

15. The computer-readable medium of claim 8, wherein the computer-readable medium further comprises computer-executable instructions that when executed perform at least:
utilizing the same 9-point industrial engagement matrix utilized to determine whether to include the first sector within the plurality of sectors as an inclusion criteria to validate a plurality of entities currently categorized as belonging to the first sector.
